(19) United States
(12) Patent Application Publication
(10) Pub. No.: US 2007/0275333 A1
(43) Pub. Date: Nov. 29, 2007

(54) Method for Controlling the Treatment of a Crystal with a Liquid

(76) Inventors: Torsten Neuefeind, Gauting (DE); Hans Brandstetter, Marzoll (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/572,247

(22) PCT Filed: Sep. 20, 2004
(86) PCT No.: PCT/EP04/10539

§ 371 Date: Apr. 19, 2007

(30) Foreign Application Priority Data
Sep. 19, 2003 (DE) 103 43 522.0

(51) Int. Cl. G03C 1/005

(52) U.S. Cl. 430/567

(57) ABSTRACT

The invention relates to a method for controlling the treatment of a crystal (2) by means of a liquid, wherein an image signal is captured by an image capturing system (200), said image signal representing a momentary image of a crystal having drops poured thereon by an electrically controllable microdosing system (11, 300), said image signal having a liquid environment whereby the image signal is treated and the momentary surface of the crystal and the liquid environment thereof is determined in the entire image by the image signal; the momentary surface is compared to a predefined desired value and a corrector drop control signal is determined and sent to the microdosing system if the surface is different from the desired value and the corrector drop signal is formed in such a manner that it represents a corrected frequency and/or variable and/or form of the drops which are to be applied to the crystal and the liquid environment thereof, which are selected such that the difference with respect to the desired value is minimised.

In protein crystallography, it is often the case that ligands or inhibitors are supposed to be introduced into a protein structure or a protein crystal before crystallographic measurement. Herein, the crystallographic structure of a protein without and with ligand or inhibitor is supposed to be compared and the spatial arrangement of the ligand or protein is supposed to be determined. Herein, all molecules or substances binding to a protein or to a polypeptide, which can, for example, have an inhibitory effect or also an agonistic effect on the function of the protein, can act as ligands. Optionally, ligands can be organic-chemical molecules or also (modified) antibodies or antibody fragments, native binding partners or fragments, optionally modified, of crystallized protein. Furthermore, heavy metal atom derivatives are regularly needed in crystallography in order to obtain the relevant phase information. A ligand in the sense of the present invention can therefore also be a heavy metal atom (salt) binding to the crystallized protein.

A method known in the art for introducing ligands, for example inhibitors, is the so-called “soaking” with a buffer consisting of the crystallization solution and the ligand. In case a ligand to be soaked into the crystal is weakly or only hardly soluble, further substances acting as improvers of solubility can be added to the buffer in order to increase solubility. These substances can be, for example, solvents like DMSO (dimethylsulfoxide), TFE, ethanol, 2-nitropropane or other organic solvents.

The soaking method has various disadvantages. Thus, one disadvantage is that, in the process of soaking, the crystals have to be exposed to a different environment, whereby the crystal may suffer damage, i.e., in particular, that the microstructure of the crystal shows irregularities after soaking, which impair the crystal's ability to diffract. If, for example, hardly soluble inhibitors or ligands are supposed to be introduced into the protein crystal structure, very high solvent concentrations are needed. Precisely said high solvent concentrations, however, often lead to destruction of the fragile protein crystals, as mentioned above.

Moreover, a further disadvantage of the conventional soaking method is its high expenditure of time. On the one hand, this is caused by the possibly numerous (repetitive) soaking processes, which, optionally with altered concentration ratios of the ligand to be soaked, have to be completed in order to obtain at all a suitable, i.e. complexed, protein crystal structure (co-crystal), which contains the ligands or inhibitors, and on the other hand by the fact that one single soaking process can already be very time-consuming because, for example, diffusion kinetics have to be taken into consideration.

It is a further disadvantage of the soaking method that X-ray-crystallographic examinations or examinations of the protein crystal by means of X-ray radiation are technically not feasible during the course of the soaking method.

Therefore, an improved device and an improved method for treating crystals have been developed, which have been described in the German Patent Application No. 103 36 110.3 also authored by the applicant of the present application. In this respect, said application is therefore incorporated in the disclosure of the present application to its full extent.

The improved device and the improved method have a holder for fixing a crystal and a micro dosage system, which is arranged in relation to the holder in such a way, that it can apply microdrops of a liquid containing, for example, solvent and at least one type of ligand onto the crystal fixed in the holder. By means of dripping on microdrops by means of the device according to the present invention, a substantially gentler treatment of crystals, and in particular protein crystals, with specific substances to be applied, which are contained in a solution, can be achieved. In the case of protein crystals, said substances can be ligands, for example inhibitors, substrates, or reactants. In the case of protein crystals, ligands will typically be agonists, substrates, antagonists, or cofactors of the crystallized proteins. According to a modification of the improved device, the crystal holder is developed in such a way that a gas stream directed toward the crystal fixed in the holder can be led through the holder. In this manner, the crystal can be kept in a defined environment during the treatment with the microdrops.

It has shown that controlling the drop treatment process is difficult, because drop treatment has to be conducted in a very precise manner in order to prevent damaging, in particular, sensitive protein crystals during the crystal treatment process.

It is therefore the problem underlying the present invention to create an improved method for controlling the treatment of a crystal with a liquid.

This problem is solved by a method for controlling the treatment of a crystal with a liquid having the following steps:
1. an image signal, which represents a momentary image of a crystal with liquid environment, is received from at least one image recording system, wherein drops containing a liquid the crystal is supposed to be treated with are applied onto the crystal by means of an electrically controllable micro dosage system during the crystal treatment process;
2. the image signal is processed and the momentary surface of the two-dimensional image region, which represents the whole of crystal with liquid environment, or the momentary volume of the whole of crystal with liquid environment are determined from the image signal;
3. the momentary surface or the momentary volume are compared to a desired value;
4. in case of deviation of the surface or the volume from the desired value, a correction drop control signal is determined and sent to the micro dosage system, wherein the correction drop signal is developed in such a way that it represents a corrected frequency and/or size and/or shape of the drops to be applied onto the crystal with liquid environment by means of the micro dosage system, which is selected in such a manner that the deviation from the desired value is minimized.

According to this solution, simple control of the crystal treatment process is achieved by means of permanently monitoring the surface of the crystal with liquid environment in a two-dimensional image or monitoring the volume of the crystal and, depending on alterations of the surface or the volume, by means of correcting, for example, the frequency, at which the drops are applied onto the crystal with liquid environment, in such a manner that a gentler treatment of the crystal is possible.

Advantageous advanced embodiments of the present invention are stated in the subclaims. Preferred embodiments of the present invention are explained in more detail with reference to the attached drawing in the following.

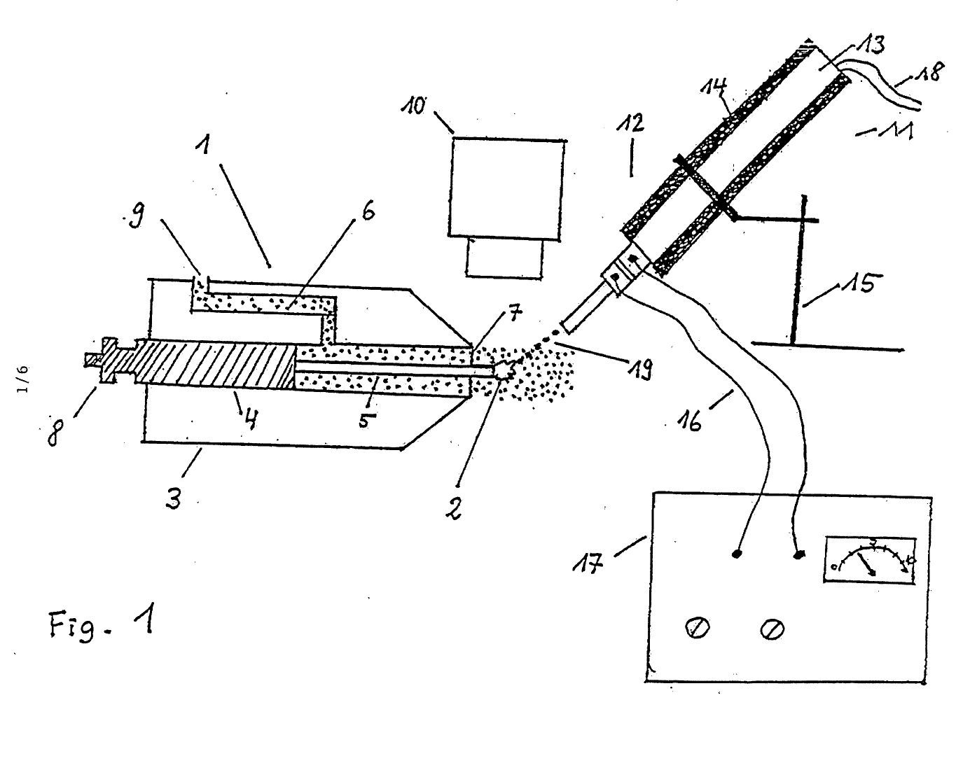

FIG. 1 shows a partially cross-sectional view of a device for treating a crystal with a solution, which is used in an embodiment of the method according to the present invention;

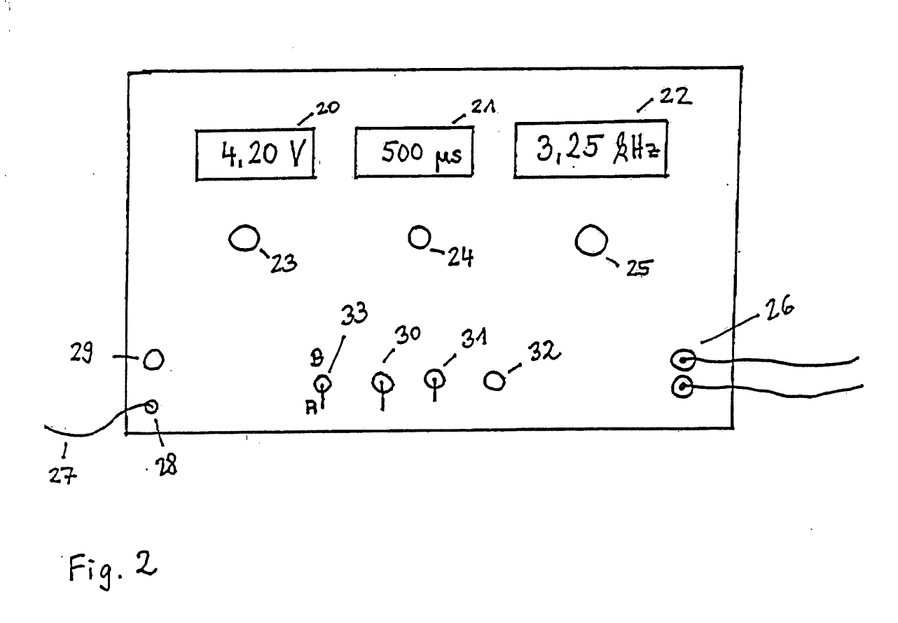

FIG. 2 shows a casing of a controlling device used in an embodiment of the method according to the present invention for controlling a micro dosage system used in an embodiment of the method according to the present invention,

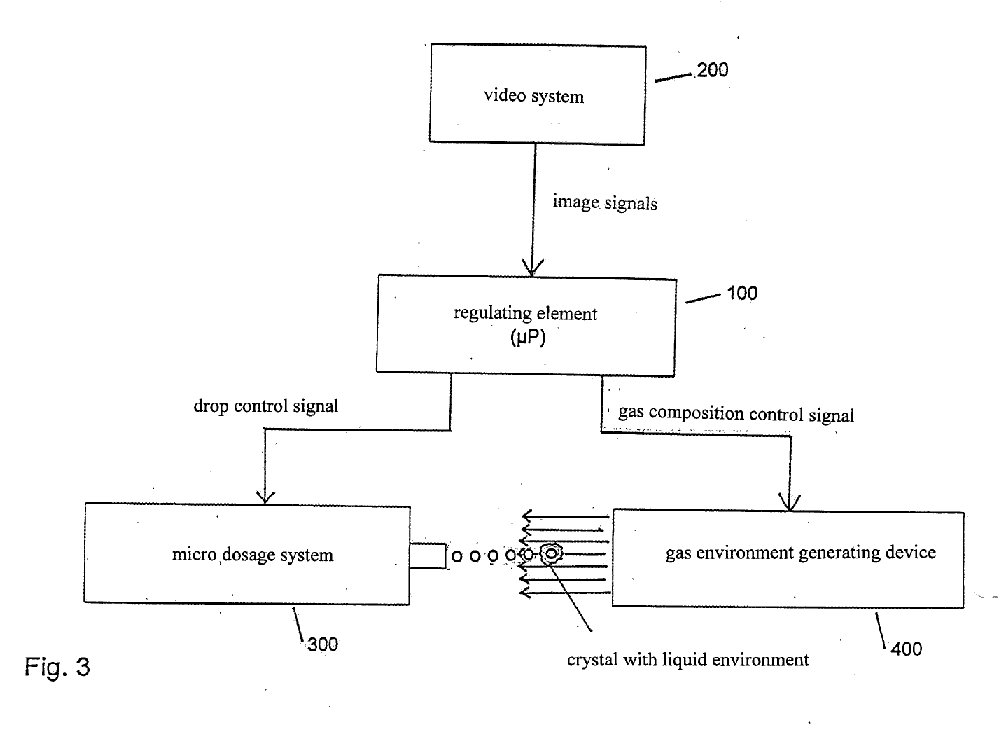

FIG. 3 shows a block diagram for the illustration of controlling the treatment of a crystal with a liquid according to an embodiment of the method according to the present invention;

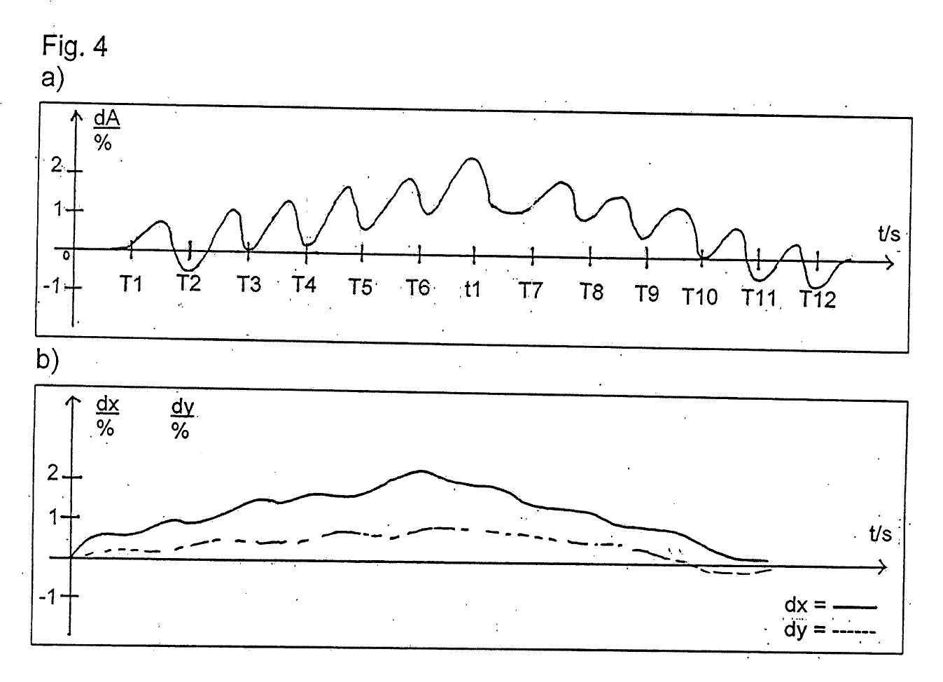

FIG. 4a) shows the alteration of the surface of the crystal with liquid environment determined according to the method of the present invention in a recorded two-dimensional image and plotted over time;

FIG. 4b) shows the alteration of the expansion of the crystal with liquid environment on the x- and y-axis in a recorded two-dimensional image and plotted over time;

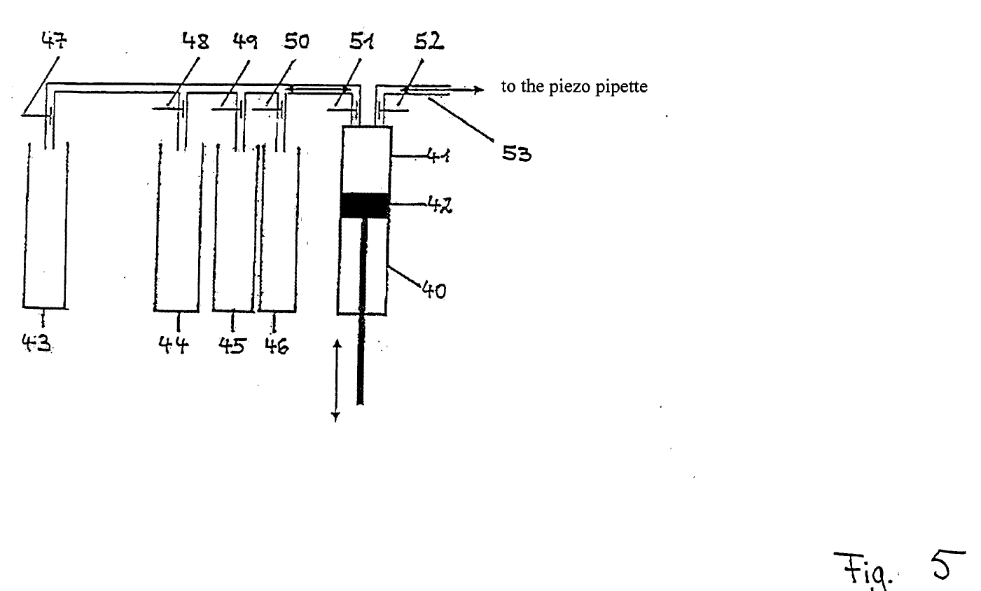

FIG. 5 shows a liquid supply system for a micro dosage system, which can be used in an embodiment of the method according to the present invention;

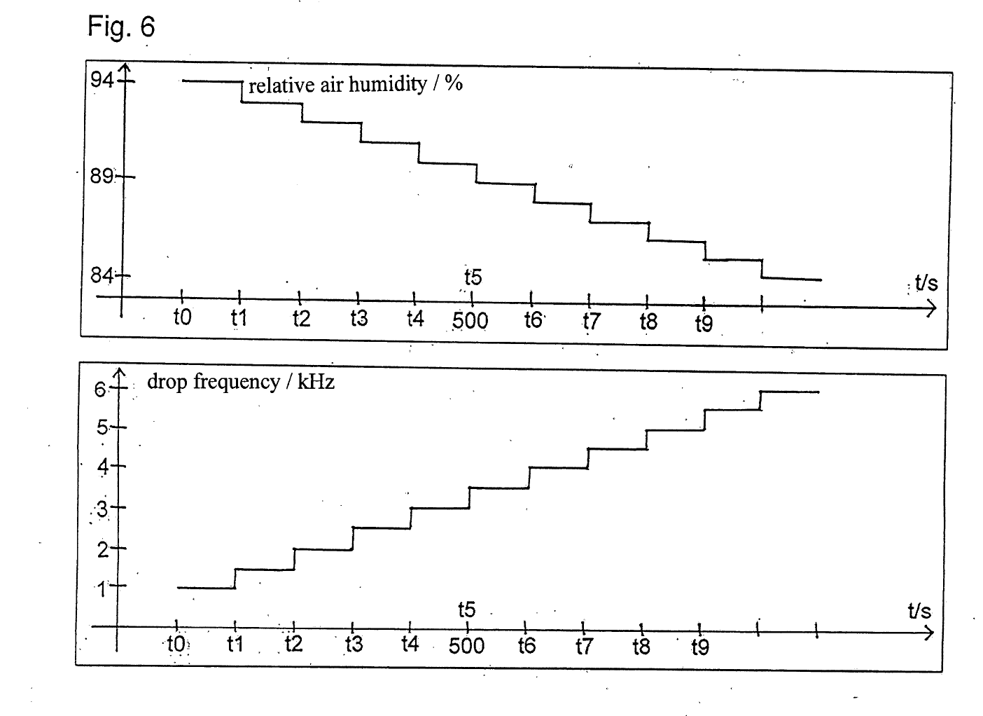

FIG. 6 shows two graphs with decreasing air humidity and increasing drop frequency.

In the following, the present invention is described by way of the example of controlling the treatment of protein crystals; the present invention can, however, also be used in an analogous manner in controlling liquid treatment of other crystals.

In order to illustrate a use of the method according to the present invention, a device for treating a crystal with a liquid is first described, which is used in an embodiment of the method and is depicted in FIG. 1. Herein, a holder 1, which serves for fixing a protein crystal 2, is depicted on the left hand side of FIG. 1. The holder depicted in FIG. 1, which in its generic category is also referred to as free mounting system, is already known from the art and has been described, for example, in the German Patent Application DE 198 42 797 C1. In this respect, said document is incorporated in the disclosure of the present application to its full extent.

The holder 1, which is depicted in a lateral cross-sectional view in FIG. 1, substantially consists of a carrier block 3 having a plug-in insertion 4, which can be inserted into an opening of the carrier block 3. A holder capillary 5 is attached to the plug-in insertion, at whose free support end the protein crystal 2 is held. The holder capillary consists of, for example, a micropipette, in which, via a pumping device, which is not depicted in FIG. 1 and which is connected with the other end of the micropipette, a negative pressure is generated, which serves for holding the protein crystal 2 at the free support end. The left end 8 of the plug-in insertion is developed in such a way that with it the holder 1 can be fixed to a goniometer head of an X-ray or synchrotron irradiation installation.

A loop, i.e. a fine loop, which can for example consist of nylon, can also be used instead of the micropipette. Such a loop is, for example, available by Hampton Research.

In an X-ray or synchrotron irradiation installation, the diffraction of X-rays can be utilized when passing through the crystal grid of the protein crystal in order to conclude the spatial arrangement of the atoms and molecules in the crystallized protein from the diffraction image or to calculate the structure by means of mathematical operations. The X-rays required can be generated, for example, by means of bombardment of copper or other materials with electrons (for example CuKa-radiation). Alternatively, the X-ray radiation can also be generated in a synchrotron, i.e. a particle accelerator, wherein the X-ray radiation is emitted by electrons accelerated in orbits. In spite of the greater equipment expenditure, the synchrotron still has various advantages compared to the conventional generation of X-ray radiation by means of electron bombardment of metals. Thus, the X-rays generated by means of synchrotrons have a higher intensity and can be selected in different wavelengths. In this manner, there is also the possibility of using “white” X-ray light and therefore of bombarding the crystal with X-ray flashes containing X-rays of all wavelengths. Furthermore, measurements can be conducted substantially faster with the synchrotron than with conventional X-ray irradiation installations.

Furthermore, a gas channel 6, whose mouth end 7 is directed toward the free support end of the holder capillary 5, whereto the protein crystal 2 is fixed, is integrated into the holder 1. Herein, the protein crystal 2 attached at the support end is enclosed entirely by the gas stream from the gas channel 6, so that a defined gas atmosphere can be generated around the protein crystal. At its end depicted as open in FIG. 1, the gas channel 6 is connected with a gas generating device and a gas mixing device, by means of which the composition of the gas stream can be adjusted variably. In case the gas surrounding the protein crystal is air, the gas mixing device can, for example, serve for regulating the air humidity to a predetermined optimal value. Furthermore, a temperature regulating device can be provided, by means of which the temperature of the gas stream can be measured and regulated to a specific value, which can be predetermined. Other gaseous substances can also be added to the gas stream, so that, for example, the nitrogen or oxygen content of the air can be modified, for example increased.

In the German Patent Application No. 10232172.8-52 having the title “Device and method for generation of a defined environment for particulate samples” (Vorrichtung und Verfahren zur Erzeugung einer definierten Umgebung für partikelförmige Proben), a device and a method have already been described, by means of which a highly exact and long-term stable humidity adjustment of a humid gas stream led through the above-described holder at the site of the particle-shaped crystal can be achieved. In this respect, this document is therefore also incorporated in the disclosure of the present application to its full extent.

A microscope having a video system 10, by means of which the protein crystal can be monitored during treatment with the substance, is mounted above the crystal. As a result of monitoring via the video system, the mode of treatment can optionally be modified or the treatment can also be discontinued.

Furthermore, the device according to the present invention for treating a crystal with a substance comprises a micro dosage system 11, which is depicted on the right hand side of FIG. 1 in a lateral cross-sectional view.

The micro dosage system 11 comprises a so-called piezo pipette 12, which is held in a tripod 15 and is directed toward the protein crystal 2 in such a way that the latter can be bombarded with drops by means of the piezo pipette. For reasons of clearness, the piezo pipette is depicted in a magnified scale in relation to the holder 1 in FIG. 1. The piezo pipette is arranged in such a way that the tip of the piezo pipette has a distance of typically 3 mm from the protein crystal. Preferably, this distance lies within a range of 1 to 5 mm; it can, however, be selected smaller or greater under specific circumstances.

The piezo pipette 12 consists of a glass capillary 13, which can, for example, consist of borosilicate glass. The diameter of the opening of the glass capillary is one of the factors, which influence the size of the microdrops released from the piezo pipette, and can, for example, lie within a range of 5 and 50 micrometers. The glass capillary 13 is enclosed by a piezoelectric element 14 consisting of a material, which shows a piezoelectric effect. This material can, for example, be a piezocrystal. Furthermore, the piezoelectric element 14 is electrically connected via two cables 16 with a controlling device 17, by means of which a voltage can be applied to the piezoelectric element 14. If a voltage pulse is applied to the piezoelectric element 14 via the controlling device 17, the piezoelectric element 14 and with it also the glass capillary 13 are contracted and a drop is shot out of the opening of the piezo pipette. Via the controlling device 17, differently shaped voltage pulses can be applied to the piezo pipette, whose shapes influence the shape and size of the microdrops and whose frequency influences the frequency of the microdrops.

In FIG. 2, a casing of a possible controlling device for controlling the piezo pipette is depicted, wherein the individual controlling possibilities are supposed to be explained by means of the switches and controlling elements of the controlling device, which are depicted in FIG. 2. First, the controlling device has three different LCD displays 20, 21, and 22. On the first LCD display 20, the current value of the voltage level of the pulse output voltage for the control signal of the piezo pipette is indicated. This value can be adjusted variably via an adjustable transformer 23. The pulse amplitude of the control signal of the pipette, which is indicated in microseconds on the second LCD display 21, can be adjusted by means of a second adjustable transformer 24. Finally, a press switch 25 is provided in order to adjust the frequency of the voltage pulses applied to the piezo pipette, which is indicated on the third LCD display 22. This frequency, which can amount to up to several kHz (for example 2 kHz), corresponds to the frequency at which the microdrops are flung out of the piezo pipette onto the crystal. The adjustment range of the frequency can, for example, lie within a range of 1 Hz to 6 kHz. The level of the pulse output voltage and the amplitude of the voltage pulses have to be adjusted in such a way that drop generation by means of the piezo pipette occurs at all.

Furthermore, the controlling device has two inputs 26, with which the two connecting cables of the piezo pipette are connected. Furthermore, a power cable 27 as well as a power connection 28 for power supply of the controlling device are provided. Via the further signal input 29, voltage pulse sequences predetermined by other electric devices can be applied in order to trigger microdrop formation and to control the sequence and shape of microdrops externally, which will be explained in more detail below.

The switch 30 is provided for switching the operation of the piezo pipette on and off. A further switch 31 allows switching between single voltage pulse operation and continuous voltage pulse operation, i.e. between single drop generation and continuous drop generation. For single drop generation, a caliper 32 can further be provided, via which single voltage pulses can be applied to the piezo pipette, if it is desired to shoot single drops onto the crystal in manual operation.

Finally, the switch 33 serves for being able to vary between different shapes of impulse of the voltage pulses applied to the piezo pipette 12. In switch position A, for example, a predetermined standard square wave voltage pulse of predetermined duration and height can be generated, while in switch position B a square wave voltage pulse can be generated, whose duration and height can be adjusted variably. In other embodiments, it is, of course, also conceivable that voltage pulses are applied, which deviate from the square shape.

Different sizes of the microdrops, which can, for example, be suitable for different crystal sizes, can be adjusted via the variation of the voltage pulse amplitudes and voltage pulse heights, which are exhibited by the voltages applied to the piezo pipette.

The glass capillary 13 of the piezo pipette 12 is typically connected via a supply duct 18 with a supply container, which is not depicted in FIG. 1 and which contains the solution to be dripped onto the protein crystal. Said solution contains the substance or the substances the protein crystal is supposed to be treated with. Herein, the top level of the liquid in the supply container should be adjusted slightly higher than the lower edge of the pipette tip. Alternatively, in a solution without supply container, the liquid can also be sucked directly via the outlet opening of the piezo pipette into the piezo pipette, in order to be able to release it again later. A tempering device can also be arranged around the supply container, in order to bring the liquid in the supply container to a desired temperature. According to one embodiment, the pH-value and/or the ionic strength (for example specific salt concentrations) of the solution can, according to the methods known in the art, be adjusted to a desired value before applying the solution onto the crystal.

In the sense of the present invention, microdrops should be understood to denote drops, whose volume is smaller than 1 nl, wherein the volume of the microdrops preferably lies between 1 nl (nanoliter) and 1 pl (picoliter), further preferably between 100 pl and 20 pl, and even more preferably between 20 pl and 1 pl. By means of the volume formula, the corresponding suitable diameters of the drops can be calculated from these quantities, if the drops are approximately assumed to be of globular shape. According to the present invention, the desired volume of the drops can be adjusted.

Herein, the microdrops of the liquid to be applied onto the crystal are preferably smaller than the volume of the crystal. Herein, a typical volume of a crystal can, for example, be in an order of magnitude of about 1 nl.

The volume of the microdrops used in a specific case is selected in dependency on the volume of the crystal. Herein, the volumina of the microdrops are smaller than 50%, for example 1 to 20%, of the crystal volume and preferably 1 to 10% of the crystal volume.

Drop generation by means of a piezo pipette is only one example for a micro dosage device. Other devices, which are capable of generating microdrops, can also be used.

Thus, for example, a micro dosage system comprising a capillary and a micro valve arranged inside said capillary can also be used. Herein, the liquid is squeezed under pressure from a supply container onto the micro valve, which is electrically opened within a short time interval and subsequently closed again by means of a controlling device in order to generate the drops. Herein, the limitation of drop size results from the still controllable opening period of the valve.

In another embodiment, an atomizer can also serve as micro dosage system. In comparison with the above-described solutions, however, an atomizer has the disadvantage that the orientation of the drops toward the crystal is more difficult. Therefore, a device ensuring the orientation of the microdrops obtained from the atomizer toward the crystal is advantageously arranged behind the atomizer.

In one embodiment of the method according to the present invention, a protein crystal is first fixed at the free support end of the holder capillary 2. Instead of the holder capillary 2, a loop, in which the protein crystal is fixed, can also be used. Herein, the protein crystal is free of any kind of surface solution and is therefore accessible for solutions, which can be directly applied externally by means of the micro dosage system. By means of the holder 1, a gas atmosphere is now typically generated around the protein crystal 2 by leading a gas stream of defined composition and temperature through the gas channel 6 of the holder 1. In the method described, this will typically be an air stream, optionally with the addition of other gaseous substances, having a regulated humidity content (i.e. water content) and a regulated temperature.

An inhibitor, which is a component of a substance that has been added to the solution, which is located in the supply container connected with the piezo pipette, is now to be introduced into the crystal structure of the protein crystal. By way of experimentation, it has shown that solutions (like for example DMSO), which are locally applied onto the surface of the crystal and have a high inhibitor concentration, do normally not damage the crystal. Electric voltage pulses are now applied to the piezo pipette 12 by means of the controlling device 17 and microdrops with the inhibitor solution are flung onto the protein crystal 2. The gas stream streaming around the protein crystal remains practically unaffected by the spraying of individual microdrops, so that the protein crystal remains within its stably defined environment. The preservation of a stable environment is of particular importance for the relatively unstable protein crystals, which are held together by low lattice binding forces, in order to prevent the crystals from being destroyed before they, for example, undergo an X-ray crystallographic examination. The humidity of the air stream surrounding the crystal can now, in interplay with size and frequency of the drops applied onto the protein crystal via the micro dosage device, be adjusted in such a way that, if possible, the crystal changes its volume only slightly by means of achieving a balance between evaporation of liquid from the crystal and increase of liquid by dripping on liquid by means of the micro dosage device. Thereby, the crystal is strained only minimally and a gentler introduction of the ligand/s via the locally applied microdrops can be achieved. This process of adjusting the optimal air humidity or the optimal drip-on frequency by means of the micro dosage device can be regulated automatically via a regulating element, which correspondingly alters the humidity of the air stream and/or the drip-on frequency in case the measured volume of the crystal changes.

In FIG. 3, such a regulating element 100 is depicted in the form of a microprocessor (μP) having a memory device (not depicted), in which commands are stored, which can bring the microprocessor to conduct the regulation procedure according to the present invention.

According to one embodiment of the method according to the present invention, an initial image of a protein crystal with liquid environment is first recorded by means of the video system before the start of the crystal treatment process. Herein, the crystal is surrounded by a thin film of liquid, which is preferably as thin as possible, at the beginning of the procedure. An image signal representing said initial image is then transferred from the video system 200 to the regulating element 100 via a connection between the video system 200 and the regulating element 100. Herein, the transfer of the image signal can, for example, be triggered by an initial image transfer trigger signal sent from the regulating element 100 to the video system 200 (via a connection, which is not depicted in FIG. 3). Alternatively, an image of the pure crystal without liquid environment can also be recorded before the initial image, in particular if the volume of the liquid environment is supposed to be calculated at the beginning of and during the crystal drip-on process.

The image signal is now evaluated in the regulating element 100 and the surface occupied by the recorded protein crystal with liquid environment in the two-dimensional recorded image is determined. Said determination can be conducted by means of one of the image evaluation methods developed in the art, for example by means of simple count of the pixels occupied by the crystal with liquid environment in the two-dimensional image in comparison with the total number of pixels. Subsequently, the determined value for the surface of the protein crystal with liquid environment is stored as desired value in the memory of the microprocessor of the regulating element.

An initial drop control signal, which is developed in such a way that it represents the initial frequency of the drops to be applied onto a crystal with liquid environment by the micro dosage system at the beginning of the crystal treatment, is now sent from the regulating element 100 to the micro dosage device 300 (for example via the input of the controlling device of the micro dosage device). In the present example, said frequency should be 2.5 kHz. However, the initial drop control signal can also be developed in such a way that it also represents further parameters of the drops beside the frequency, for example initial size and/or initial shape of the drops.

An image transfer trigger signal is now once more sent from the regulating element 100 to the video system 200, which thereupon once more sends the momentary image data of the crystal with liquid environment to the regulating element 100. The image signal is now received in the regulating element, is processed, and the momentary surface of the two-dimensional image region representing the whole of crystal with liquid environment is determined from the image signal. In the present embodiment, the initially defined desired value, which is stored in the memory of the regulating element and corresponds to the initial surface, is preferably supposed to be maintained, so that a stable balance of evaporation of liquid and increase of liquid by dripping onto the crystal with liquid environment is achieved, which least strains the sensitive protein crystal. The once more determined surface is now compared with the previously stored desired value and, in case of deviations between surface and desired value, a correction drop control signal is determined and sent to the micro dosage system, wherein the correction drop signal is developed in such a way that it represents a corrected frequency (and/or drop shape, and/or drop size) of the drops to be applied onto the crystal with liquid environment by means of the micro dosage system, which is selected in such a way that the deviation from the desired value is minimized. It is to be assumed that, in the present case, a deviation between the once more determined surface value and the desired initial value occurred, wherein the once more determined surface was by 5% larger than the initial surface. This means that the drop frequency of the micro dosage device is adjusted too high, so that the crystal with liquid environment continuously accumulates liquid, whereby the protein crystal is endangered with respect to its stability. Therefore, a correction drop control signal, which for example corresponds to a frequency of 1.8 kHz, is determined by the microprocessor of the regulating element 100 in the present case. Said correction drop control signal is now sent to the controlling device of the micro dosage device, which in turn applies the signal to the piezo pipette, whereby the frequency of the drops and therefore the size of the whole of crystal with liquid environment decreases. If, when repeating the described method, it should now turn out that the once more recorded image data, which are transferred to the regulating element, indicate a downward deviation from the desired surface value, the frequency of the drops would once more be altered via a drop control signal, which is once more determined and sent to the micro dosage device, until a balance between evaporation of liquid and increase by dripping on is established. The method is repeated until the crystal treatment process is successfully completed. Instead of, or together with, the frequency of the drops, their size and/or shape can also be adjusted via modified drop control signals.

FIG. 4 a shows a graphic representation of the course of alteration of the surface of the crystal with liquid environment in the image recorded by the image recording system, which was measured according to the method according to the present invention, wherein the alteration is given in percent. According to a preferred embodiment, the surface values determined at regular intervals can be stored and then sent to a monitor, where they are then indicated for the operator. In FIG. 4a), one microdrop was dripped onto the crystal with liquid environment by means of the micro dosage system activated by the regulating element at the points in time T1, T2, T3, . . . , T12 in each case. After each drop, the surface alteration dA, which is determined via the video system in connection with the regulating element, briefly increases, wherein dA subsequently descends due to water evaporation, until a new drop is applied onto the crystal with liquid environment by means of the micro dosage system. Moreover, it can be seen from FIG. 4a) that the surface alteration continuously increases until point in time t1. In order to counteract this, a signal is sent to the micro dosage system by the regulating element at point in time t1, which represents a lower drip-on frequency. Thereby, fewer drops are dripped on per time unit, which causes the surface alteration dA to decrease again gradually after point in time t1. In FIG. 4b), further graphs are depicted, which can be indicated on the monitor. Herein, dx denotes the percentage alteration of the expansion of the image “crystal with liquid environment” in x-direction in the total recorded image. Correspondingly, dy denotes the percentage alteration of the two-dimensional image of the crystal with liquid environment in y-direction. Both values can be determined, for example by means of pixel analysis, in the regulating element from the image received from the video system. The values indicate whether the whole of “crystal with liquid environment” has expanded more in one or the other direction.

According to a further embodiment of the method according to the present invention, it can also be attempted to achieve a balance between evaporation of liquid and increase of liquid of the whole of crystal with liquid environment by means of controlling the composition of the gas environment of the protein crystal. To this end, in the case of deviations between the desired surface value and the momentary surface value measured via the image signal, a gas composition control signal can be sent to the gas environment generating device 400 via the regulating element 100, by means of which, if the gas is air having a specific humidity content, said humidity content can be altered until a balance between evaporation of the whole of “crystal with liquid environment” and liquid increase of the whole of “crystal with liquid environment” is achieved. It is known in the art how this adjustment of air humidity can be achieved and is described, for example, in the above-mentioned German Patent Application No. 10232172.8-52 having the title “Device and method for generation of a defined environment for particulate samples” (Vorrichtung und Verfahren zur Erzeugung einer definierten Umgebung für partikelförmige Proben) according to which a highly exact and long-term stable humidity adjustment of a humid gas stream led through the above-described holder at the site of the particle-shaped crystal can be achieved. The higher the humidity content in the air is adjusted, the more water the crystal with liquid environment will take up from the gas environment, so that, for example by means of adjusting a higher humidity content in the gas stream, an exceedingly strong evaporation of water from the whole of “crystal with liquid environment” can be counteracted.

According to a further alternative embodiment of the method according to the present invention, both the addition of drops and the composition of the gas stream surrounding the crystal with liquid environment can, however, also be regulated simultaneously. To this end, in the case of deviations between desired surface value and actual surface value, the regulation element has to determine an ideal combination of drop addition (i.e. drop frequency, drop size, drop shape) and composition of the gas environment and send corresponding drop control correction signals or gas composition control signals to the micro dosage device or the gas environment generating device.

According to a further embodiment of the method according to the present invention, the volume of the crystal with liquid environment can also be determined instead of the surface of the crystal with liquid environment in a recorded image. This, however, requires several video systems, by means of which the crystal with liquid environment can be recorded from different positions. The images recorded from different positions at the same point in time can then be evaluated in the regulating element in order to obtain volume information from the images. For evaluation, for example photogrammetric methods or other methods known in the art, which allow the determination of the volume of a body from two-dimensional images of the body, which were recorded from different positions and partially contain identical points of the body.

According to a further embodiment, the piezo pipette can also be equipped with a special liquid supply system, by means of which it is possible to control the supply of different liquids into the piezo pipette time-dependently in a desired manner. FIG. 5 depicts such a liquid supply system. The liquid supply system depicted in FIG. 5 comprises a precision syringe 40 (electrically controllable), which consists of a cylinder 41, wherein a piston 42 driven by a motor (not depicted in FIG. 5) can move up and down. If the piston moves downward, different liquids from the liquid containers 43, 44, 45, or 46 can be sucked into the cylinder, if one of the corresponding electrically controllable valves 47, 48, 49, or 50 is opened and, in addition, the electrically controllable valve 51 located in front of the cylinder is opened. If the valve 51 is then closed again, if the electrically controllable valve 52 located at the outlet of the cylinder is opened, and the piston 42 is driven upward, then the liquid sucked in can be led to the piezo pipette via the liquid supply duct 53 leading to the piezo pipette in order to then be finally able to be applied onto the crystal in the form of drops.

The containers 45 and 46 can, for example, contain two different solutions with different ligands, which are supposed to form a complex with the protein of the crystal to be dripped on. Herein, the treatment of the crystal can, for example, be conducted in such a way that first the solution 1 from the container 45 and subsequently the solution 2 from the container 46 are dripped onto the crystal. In between the two solutions, a cleaning solution, which is located in the container 44, can be flushed through the ducts. The further container 43 serves as waste container in order to take up those amounts of liquid, which are not needed anymore and have to be removed from the supply system. By means of suitable time-dependent activation of the valves 47-52 and of the piston 42, the desired solutions in the desired amounts can now be delivered to the piezo pipette.

According to a preferred embodiment of the method according to the present invention, the time-dependent activation of the valves can also be conducted by means of the microprocessor (μP) of the regulating element denoted with 100 in FIG. 3. Herein, a desired time-dependent sequence of opening and closing moments of the electrically controllable valves is first stored in the memory of the μP. During the crystal treatment process, electric signals or radio signals are sent from the regulating element to the electrically controllable valves at the stored points in time in order to open and close the valves in an organized manner. Moreover, the liquid containers can also be equipped with electrically readable level measurement devices, which, after the regulating element 100 has sent out an interrogation signal, send a signal representing the current level of the container back to the regulating element 100. The regulating element can evaluate said level signals and indicate them for the operator on a monitor connected with the regulating element, so that the operator is constantly informed about the current levels. Preferably, the regulating element can also issue a warning signal on the monitor or in acoustic form, in case the liquid level falls below a specific critical residue value (for example 5%), which was previously stored in the memory of the μP, during the crystal treatment process, so that the operator can arrange for refilling the liquid container in time. Instead of the valves depicted in FIG. 5, other flow regulators, which can be controlled electrically, can also be used, for example mass flow regulators.

According to a further embodiment of the present invention, several micro dosage systems, for example several piezo pipettes, can also be used, by means of which different or also identical substances (for example at two different, locally separated regions of the crystal) are applied onto the crystal in each case. Such an arrangement can, for example, be advantageous if two different ligands are supposed to be introduced into a protein crystal structure. Said ligands are then solved in different solutions, which are filled into the two liquid supply containers of two piezo pipettes. The two solutions containing the different ligands are then applied onto the protein crystal in the form of microdrops via the two piezo pipettes. Here, different voltage pulses and voltage pulse sequences can be applied to the piezo pipettes via the controlling device, which controls drop generation and is connected with one of the piezo pipettes in each case, in order to thus achieve an optimal shape and frequency of the microdrops, which is ideal for the respective ligand.

The use of two micro dosage systems, by means of which two different substances that come together only on the crystal are applied separately, is, in particular, also advantageous if the crystallized protein has a catalyst function for the two substances, which are both bound as reactants in the crystallized protein. If the spraying of both reactants is conducted separately by means of two micro dosage systems during the X-ray irradiation of the protein crystal, the reaction of the reactants can be observed by means of catalytically using the crystallized proteins. Of course, the stability of the crystal, i.e. that the crystal must not lose its structure due to structural shifts of the crystallized proteins as it would thereby lose its ability to diffract, is a prerequisite for such an X-ray crystallographic examination.

With the use of several micro dosage systems, which are activated by means of the regulating element, the regulation has to be adapted correspondingly. Here, the regulating element has to calculate correction drop control signals for each of the micro dosage systems and then send them to the respective systems after measuring the current expansion of the crystal with liquid environment via the video system. Herein, beside a standard concerning the total surface or the total volume of the crystal with liquid environment determined from the images of the video system, the desired reaction kinetics must also be taken into account, i.e. specific constraints with respect to the ratio of amounts of liquid to be dripped on from the different micro dosage systems per time unit can be predetermined by means of storing them in the memory of the μP in the form of a kind of liquid ratio dispersion diagram.

According to a further embodiment of the method according to the present invention, a specific time-dependent course of the composition of the gas environment surrounding the crystal with liquid environment and a specific time-dependent course of the frequency (and/or size and/or shape) of the drops to be applied onto the crystal with liquid environment by means of the micro dosage system can also be defined before the start of the crystal treatment process. In this case, a corresponding course of events is stored in the memory of the μP in the form of a lookup table, in which the individual gas environment control signal values and frequency control signal values are assigned to the control points in time. The frequency control signals are then sent to the micro dosage system and the gas environment control signals are sent to the gas environment generating device at the stored control points in time during the crystal treatment process. For one embodiment, wherein the gas air is depicted having a specific humidity content (H₂O). FIG. 6 shows how the relative humidity is gradually lowered during the course of the crystal treatment process, viz from 94% down to 84%. Herein, at the points in time t0, t1, t2, . . . , t10, gas environment control signals are in each case sent from the regulating element to the gas environment generating device, which in this case consists of an air humidity adjusting device. During the general reduction of the relative air humidity of the air stream surrounding the crystal with liquid environment, the drop frequency is simultaneously increased gradually from 1 kHz to 6 kHz by means of sending corresponding frequency control signals from the regulating element 100 to the micro dosage system at the points in time t0, t1, t2, . . . , t10. The volume of the crystal with liquid environment is substantially maintained constant by means of decreasing the air humidity while simultaneously increasing the drip-on frequency of the drops containing water onto the crystal with liquid environment. This leads to a modest strain on the crystal, which is particularly advantageous in the case of sensitive protein crystals. Adjusting the air humidity/drop frequency by means of the regulating element in the above-described manner is conducted between the points in time t0, t1, t2, . . . , t10 depicted in FIG. 6 by means of determining and sending corresponding correction signals via measuring the volume of the whole of crystal with liquid environment (or its surface in the image) and comparing it with a desired volume (or surface) value (which, for reasons of clearness, is not depicted in FIG. 6). According to a further embodiment of the method according to the present invention, a specific desired gradient (as is, for example, depicted in FIG. 6) of air humidity can also be programmed in the regulating element before the crystal treatment, wherein the drop frequency suitable for maintaining the current volume of the whole of crystal with liquid environment constant is automatically determined during the crystal treatment with the liquid dripped on. To this end, the above-described method can be applied, wherein the images of the whole of crystal with liquid environment, which are recorded by means of the video system, are evaluated by the regulating element and subsequently the determined surface or volume value is compared to a desired value, exceeding or staying below which triggers a corresponding correction drop control signal, by means of which the frequency (and/or shape, size) of the drops released by the micro dosage system is correspondingly altered, so that the volume of the crystal with liquid environment remains approximately constant.

It is a substantial advantage of the above-described embodiments, wherein an air humidity gradient is employed, that in this manner the leadthrough velocities for the crystal treatment processes can be considerably increased, as it is possible to operate at higher drip-on frequencies. This is particularly advantageous in the case of such inhibitors or other substances to be introduced into protein crystals, which only have weak water solubility, as a very large number of drops have to be applied onto the protein crystal in order to be able to successfully complete the process of crystal treatment.

Of course, other solvents, in which inhibitors or other substances to be introduced into the crystal structure can be solved, can also be used instead of water. Thus, for example, DMSO, ethanol, isopropanol, or DMF (dimethyl formamide) can be used. Many inhibitors are more easily soluble in said solvents than in water, whereby the crystal treatment method can be accelerated, as fewer drops have to be applied onto the crystal. A solvent other than water can also be added to the gas stream, which is led around the crystal during the drip-on procedure. With the use of other solvents, the drop size, which will usually be larger than the drop size of water, is also to be taken into consideration. Thus, for example, DMSO has a drop size larger than that of water by a factor of 4 to 5. However, the drop size must not be too large, as it has to be within a specific ratio in relation to the size of the crystal, as is mentioned above. Moreover, mixtures of different solvents can also be used.

According to a further embodiment of the method according to the present invention, a stroboscope with flashlight can also be provided in order to allow monitoring the drops during the crystal treatment process. Herein, the stroboscope can be connected with the controlling device triggering drop generation and can simultaneously be activated by the signal triggering the release of a drop, so that drop release and flashlight are synchronized.

Furthermore, a device for rotating the crystal can also be provided in a further embodiment of the method according to the present invention. The crystal treatment process can be completed faster if the crystal is rotated during the drip-on procedure, as an even dispersion of the liquid across the surface of the whole of “crystal with liquid environment” occurs. In the case that images are furthermore recorded by means of the image recording system during the rotation, the volume of the crystal with liquid environment can be calculated from said images by means of known image evaluation methods.

As both the crystal and its liquid environment are normally almost transparent and the image recording system can only recognize the limits of the whole of “crystal with liquid environment” (which is normally recorded in front of a white background), an automatic pixel filling function, according to which those pixels in the image, which are located within the limits of the whole of “crystal with liquid environment”, which are recognizable by black pixels, are filled up with black pixels, can be provided for the purpose of determining surface or volume before the image evaluation. Specific other white pixel regions within the crystal or the liquid environment, which result from light reflections or other undesired optical effects, can also be filled up automatically with black pixels in order to allow a correct determination of surface or volume. In surface or volume determination, the ratio of black and white pixels is then simply evaluated after conducting the above-described correction.

1. A method for controlling the treatment of a crystal with a liquid comprising the following steps:
(a) receiving from at least one image recording system an image signal representing a momentary image of a crystal with liquid environment, wherein drops containing a liquid with which the crystal is to be treated are applied onto the crystal using an electrically controllable micro dosage system during the crystal treatment process;
(b) processing the image signal and determining the momentary surface of the two-dimensional image region representing the whole of crystal with liquid environment or the momentary volume of the whole of crystal with liquid environment from the image signal;
(c) comparing the momentary surface or the momentary volume to a desired value; and
(d) determining a correction drop control signal in case of a deviation of the surface or the volume from the desired value and sending said signal to the micro dosage system, wherein the correction drop signal is developed in such a way that it represents a corrected frequency, size and/or shape of the drops to be applied onto the crystal with liquid environment, which corrected frequency, size and/or shape is selected in such a way that the deviation from the desired value is minimized.

2. The method of claim 1, further comprising the step:
(e) in the case of deviation of the surface or the volume from the desired value, sending a gas composition correction signal to an electrically controllable gas environment generating device, which generates a gas environment of defined composition around the crystal with liquid environment, wherein the gas composition correction signal represents an altered composition of the gas environment.

3. The method of claim 1, wherein the steps are repeatedly conducted until the crystal treatment process is completed.

4. The Method of claim 1, further comprising before step (a) of the method, sending an initial drop control signal to the micro dosage system, which signal represents the initial frequency, initial size and/or initial shape of the drops to be applied onto a crystal with liquid environment at the beginning of the crystal treatment.

5. The method of claim 1 further comprising recording an initial image of the crystal with liquid environment by the image recording system before the start of the crystal treatment with the liquid and receiving a signal representing the initial image.

6. The method of claim 5, further comprising determining the momentary surface of the two-dimensional image region representing the whole of crystal with liquid environment or the momentary volume of the whole of crystal with liquid environment from the initial image and later using the corresponding value as desired value.

7. The method of claim 1, wherein the gas environment generating device is capable of generating an air stream having defined air humidity around the crystal with liquid environment.

8. The method of claim 7, wherein the air humidity of the air stream surrounding the crystal with liquid environment is altered by the gas composition correction signal.

9. The method of claim 1, wherein the correction drop control signal is developed in such a way that it represents the frequency, drop size and/or drop shape at which the drops are dripped onto the crystal.

10. The method of claim 2, further comprising, before the crystal treatment process, receiving a signal representing a specific time-dependent course of the composition of the gas environment and a specific time-dependent course of the frequency size and/or shape of the drops to be applied onto the crystal with liquid environment by the micro dosage system.

11. The method of claim 8, further comprising, before the crystal treatment process, receiving a signal which represents a drop frequency gradually increasing during the crystal treatment process and a gradually decreasing air humidity of the air stream surrounding the crystal.

12. The method of claim 2, further comprising predetermining a specific time-dependent course of the gas composition and automatically determining the matching time-dependent course of the frequency, size and/or shape of the drops to be applied onto the crystal with liquid environment by the micro dosage system.

13. A computer-readable medium, comprising commands stored thereupon, which commands are capable of causing a processor to conduct the method of claim 1.

14. The computer-readable medium according to claim 13, which comprises a CD-ROM.

15. The computer-readable medium according to claim 13, which comprises a DVD.

16. The method of claim 1, wherein the micro dosage system is capable of generating microdrops of the liquid to be applied onto the crystal, which microdrops have a volume that is smaller than the volume of the crystal.

17. The method of claim 16, wherein the micro dosage system is capable of generating microdrops having a volume of between 10 and 20 percent of the crystal volume.

18. The method of claim 16, wherein the micro dosage system is capable of generating microdrops having a volume of between 1 nl and 100 pl.

19. The method of claim 1, wherein the micro dosage system furthermore comprises a liquid supply system, which is capable of supplying to a drop generating part of the micro dosage system in a time-dependently controlled manner different liquids to be dripped onto the crystal.

20. The method of claim 19, wherein the liquid supply system of the micro dosage system comprises an electrically controllable precision syringe and a duct system, capable of connecting with different liquid supply containers and with the drop generating part of the micro dosage system via electrically controllable valves in order to supply liquid for drop generation to the micro dosage system.

21. The method of claim 1, wherein the micro dosage system is further comprises a piezo pipette, which forms the drop generating part.

22. The method of claim 21, piezo pipette comprises a capillary, which is enclosed by a piezoelectric element.

23. The method of claim 21, wherein the micro dosage system furthermore comprises a controlling device, which is electrically connected with the piezo pipette and which is capable of applying differently shaped voltage pulses to the piezo pipette, whose shapes control the shape and size of the microdrops and whose frequency controls the frequency of the microdrops.

24. The method of claim 1, wherein the micro dosage system comprises a capillary and a micro valve arranged inside the capillary.

25. The method of claim 24, wherein the micro dosage system furthermore comprises a controlling device for switching the micro valve on and off in order to generate the microdrops.

26. The method of claim 1, wherein several micro dosage systems are provided, which are arranged in relation to the holder such that the micro dosage systems are capable of applying microdrops of different liquids onto the crystal with liquid environment.

27. The method of claim 1, wherein the liquid comprises a solution.

28. The method of claim 27, wherein one or more substances, to be introduced into the structure of the crystal or to be reacted with or in the crystal, are dissolved in the solution.

29. The method of claim 28, wherein the one or more substances comprise one or more ligand/s or inhibitor/s.

30. The method of claim 28, wherein the one or more substances comprise one or more reactant/s to be reacted with or in a protein crystal.

31. The method of claim 27, wherein the solution comprises water and a substance to be interacted with a protein crystal dissolved therein.

32. The method of claim 31, wherein the substance comprises an inhibitor or ligand with low water solubility.

33. The method of claim 16, wherein the micro dosage system is capable of generating microdrops having a volume of between 5 and 10 percent of the crystal volume.

34. The method of claim 16, wherein the micro dosage system is capable of generating microdrops having a volume of between 100 nl and 20 pl.

35. The method of claim 16, wherein the micro dosage system is capable of generating microdrops having a volume of between 20 nl and 4 pl.
